(19) United States
(12) Patent Application Publication
(10) Pub. No.: US 2004/0016003 A1
(43) Pub. Date: Jan. 22, 2004

(54) Digital video receiver and stream creating method thereof

(75) Inventor: Joo-Yoen Lee, Gyunggi-do (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD

(21) Appl. No.: 10/600,534

(22) Filed: Jun. 23, 2003

(30) Foreign Application Priority Data
Jun. 22, 2002 (KR) 2002-35174

(51) Int. Cl. H04N 7/16

(52) U.S. Cl. 725/153

(57) ABSTRACT

A digital video receiver and a data stream creating method thereof. The digital video receiver receives and decodes a broadcasting program, creates a predetermined type of data stream and transmits the data stream to a recording/reproducing apparatus which is connected thereto through an interface. The digital video receiver includes a program information converter which converts the program information included in the broadcasting program into a format suitable for the recording/reproducing apparatus connected thereto through the interface, and a stream generator which receives the converted program information and decoded broadcasting data to generate a data stream with the received information and data. Accordingly, program information can always be added to the broadcasting program before transmission even when the received program is in a format different from the transmission format for the recording/reproducing apparatus.

### BACKGROUND OF THE INVENTION

1. Field of the Invention

This application claims the benefit of priority of Korean Patent Application No. 2002-35174, which is hereby incorporated by reference.

The present invention generally relates to a digital video receiver. More particularly, the present invention relates to a digital video receiver capable of recording certain information about a particular received program while performing a recording operation with respect to a recording medium through a digital interface. The invention further relates to a stream creating method with respect to the digital video receiver.

2. Description of the Related Art

In several countries, for example the United States and Korea, a broadcasting standard devised by the ATSC (Advanced Television Systems Committee) has been adopted as the digital broadcasting standard. According to the ATSC standard, digital video receivers receive bit streams of data corresponding to an ATSC compliant digital broadcasting program. The received data is in the form of packetized data.

In the bit streams corresponding to the digital broadcasting program, a certain piece of information is additionally included regarding the program. This additional program information includes data for identifying the packet that includes a selected program, and for combining the same. The program information also includes information about the program guide for the program data being received, and the text information.

The ATSC standard includes program information about the Program and System Information Protocol (PSIP). The tables defined by the PSIP include a System Time Table (STT), Master Guide Table (MGT), Virtual Channel Table (VCT), Channel Information Table (CIT), Event Information Table (EIT) and Extended Text Table (ETT).

The STT is the simplest and smallest of the PSIP tables. Its function is to provide a reference for time of day to the receiver.

The purpose of the MGT is to describe everything about the other tables, listing features such as version numbers, table sizes, and packet identifiers (PIDs) of the transport stream.

The VCT contains the set of data that enables a receiver to tune and locate the service being broadcast. The VCT is essentially a list containing information about each service that a broadcaster creates or has announced that it will create within the TS.

The CIT is the extension of the program linking table of the MPEG-2 system, and provides detailed information about the name of the channel and its carrier frequency, etc.

The EIT is the PSIP table that carries program schedule information for each virtual channel. Each instance of an EIT covers a three-hour time span, and provides the information such as, event start time, event duration, event title, a pointer for optional descriptive text of the event, etc., for each programming source.

The ETT is an optional component used to provide detailed descriptions (called Extended Text Messages, ETMs) of virtual channels or events.

Meanwhile, the ATSC digital broadcasting program can be recorded on the recording medium through the IEEE1394 interface. The IEEE1394 is provided with a specification to transmit the information about programs using various tabulated data, Such as, PAT, PMT, SIT, DIT of the Program Specification Information (PSI).

SIT (Selection Information Table) refers to system information, and DIT (Discontinuity Information Table) refers to data information. Further, PAT (Program Association Table) refers to information about a table, and PMT (Program Map Table) refers to information about audio and video.

In receiving the terrestrial waves containing the PSIP therein, and storing the received waves on the recording medium, for example in accordance with DVHS technology using the IEEE1394 interface, since the SIT and DIT of the IEEE1394 are not transmittable in the ATSC system, the corresponding program information regarding, for example, the caption function, the event time and title, channel rating, etc., cannot be inserted in the program. Such program information is also not displayed during the reproduction of the stored program.

### SUMMARY OF THE INVENTION

In view of the above-discussed disadvantages attendant with conventional digital video receivers, it is an object of the present invention to provide a digital video receiver capable of recording certain data regarding a particular broadcasted program that is presently not recordable. This object and others is achieved through the generation of a table having a format suitable for the recording method being adopted, based on the program information included in the program being received, and a stream creating method thereof.

In accordance with one embodiment of the present invention, a digital video receiver is proposed that receives and decodes a broadcasted program, and creates a predetermined type of data stream. The data stream is transmitted to a recording/reproducing apparatus connected to the digital receiver through an interface. Further, a digital video receiver according to the present invention includes a program information converter for converting program information included in the broadcasted program into a format suitable for the recording/reproducing apparatus connected thereto through the interface. Also, a stream generator is provided for receiving the converted program information and the decoded broadcasted data, and for creating a data stream with the received information and data.

Also provided in accordance with an embodiment of the invention is a program information analyzer for analyzing the program information included in the data stream.

The program information converter includes a table generator for creating at least one new table in a suitable format using at least one of a plurality of tables of the program information.

According to one embodiment, the program information is PSIP (Program and System Information Protocol) information when the broadcasted program is in ATSC form at.

At least one of a selection information table (SIT), a discontinuity information table (DIT), a program association table (PAT), and a program map table (PMT) is created using a Virtual Channel Table (VCT), Master Guide Table (MGT), System Time Table (STT), Event Information Table (EIT) and Extended Text Table (ETT) of the PSIP information.

An exemplary interface compatible with an embodiment of the invention is an IEEE1394 interface.

Also, in a stream creating method of a digital video receiver according to the present invention, where the receiver receives and decodes a broadcasted program, creates a predetermined type of data stream, and then transmits the data stream to a recording/reproducing apparatus connected thereto through an interface, the stream creating method includes the steps of (a) converting a program information included in the broadcasted program into a format suitable for the recording/reproducing apparatus that is connected thereto through the interface, and (b) creating a data stream containing the converted program information.

### BRIEF DESCRIPTION OF THE DRAWINGS

The above objects and other features of the present invention will become more apparent by describing in detail a preferred embodiment thereof with reference to the attached drawings, in which:

FIG. 1 is a block diagram illustrating a digital video receiver connected to a digital recording/reproducing apparatus via an IEEE1394 cable according to one preferred embodiment of the present invention;

FIG. 2 is a detailed block diagram of the digital video receiver of FIG. 1; and

FIG. 3 is a flowchart illustrating a method for creating a stream of the digital video receiver of FIG. 2.

### DETAILED DESCRIPTION OF THE INVENTION

Hereinafter, the present invention will be described in detail with reference to the accompanying drawings.

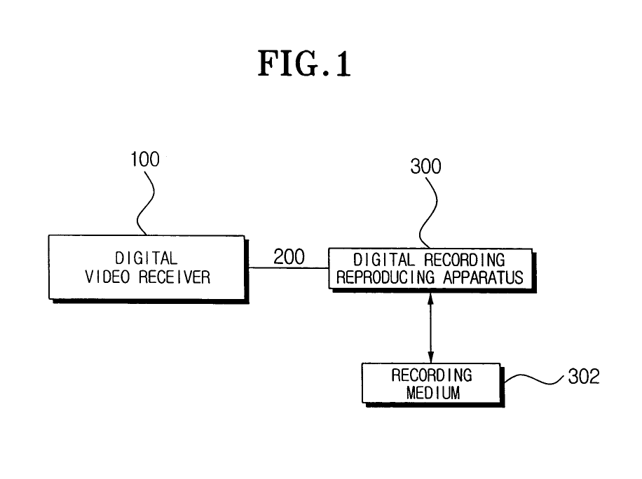

Referring to FIG. 1, the digital video receiver 100, according to one embodiment of the invention, is connected to the digital recording/reproducing apparatus 300 through the IEEE1394 cable 200.

The digital video receiver 100 receives digital broadcasting programs from systems compatible with digital video broadcasting (DVB) (not shown), a digital satellite system (DSS) (not shown) or a digital versatile disc (DVD) (not shown). Further, the digital video receiver 100 encodes the received broadcasting programs in the Moving Picture Experts Group 2—Transport Stream (MPEG2-TS), and transmits the encoded data to the digital recording/reproducing apparatus 300 by using IEEE1394 cable 200.

A digital television may be applied as the digital video receiver 100. Further, a digital VCR using digital video camcorder (DVC) format or D-VHS format may be applied as the digital recording/reproducing apparatus 300. The digital recording/reproducing apparatus 300 records the received MPEG2-TS on the recording medium 302.

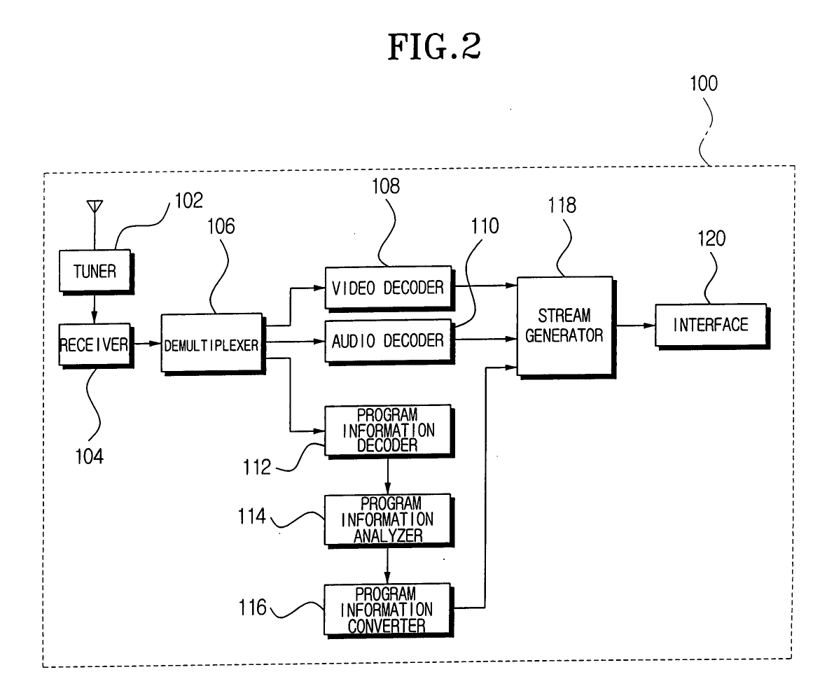

As shown in FIG. 2, the digital video receiver 100 includes a tuner 102, a transport stream (TS) receiver 104, a demultiplexer 106, a video decoder 108, an audio decoder 110, a program information decoder 112, a program information analyzer 114, a program information converter 116, a stream generator 118 and an interface 120.

The TS receiver 104 receives the TS corresponding to the channel selected through the tuner 102. The TS includes audio and video data representing contents of the broadcasting program, and also other relevant informational data.

The demultiplexer 106 multiplexes the video signal data, audio signal data and informational data signal of the received TS.

The video decoder 108 and the audio decoder 110 respectively decode the video signal and the audio signal as inputted. The video decoder 108 and the audio decoder 110 process the MPEG-compatible data stream to record the data on the recording medium such as a digital video tape 300.

The program information decoder 112 decodes the PSIP information data received through the demultiplexer 106.

Further, in order to obtain program information that includes the program guide and the system information, the program information analyzer 114 analyzes the decoded PSIP information data and thereby obtains the EIT and ETT tables.

The program information converter 116 converts the program information data included in the broadcasting program into a suitable format for the recording/reproducing apparatus 300 that is connected through the interface 120. The program information converter 116 includes a table generator (not shown). The table generator encodes the inputted signals using the EIT and the ETT tables obtained at the program information analyzer 114, creates the SIT and DIT in accordance with the IEEE1394 specification, and creates the PAT and PMT tables in accordance with the MPEG specification.

The SIT, DIT, PAT and PMT tables respectively store necessary information such as system information, data information, table information and audio/video information.

Also, program information including additional information such as program guide information, explanation regarding the broadcasting program and data supporting identification and combination of such additional information can be tabulated.

The stream generator 118 receives an input of decoded video/audio signals from the video decoder 108 and the audio decoder 110, and receives an input of guide information regarding the SIT, DIT, PAT and PMT from the program information converter 116. The stream generator 118 then creates an MPEG transport stream (TS) including the program information using the signals as inputted, and outputs the created MPEG-TS.

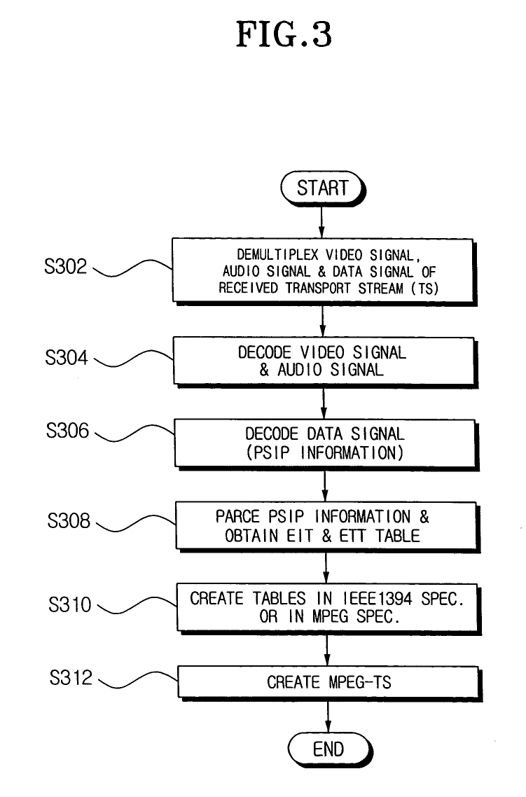

FIG. 3 is a flowchart illustrating a process of creating a stream of digital video in the receiver of FIG. 2.

The video signal, audio signal and informational, or data, signal of the received TS are multiplexed in operation S302.

The video signal and the audio signal are decoded in operation S304.

The PSIP information among the data signal is decoded in operation S306.

EIT and ETT tables are obtained based on the analysis on the decoded PSIP information in operation S308.

The SIT and DIT in IEEE1394 specification, and program information, such as PAT and PMT tables in the MPEG specification, are created based on the EIT and ETT tables in operation S310.

An MPEG transport stream is created using the decoded video and audio signals, and further program information in operation S312.

With the digital video receiver and a stream creating method thereof according to the present invention, program information can always be added to the broadcasting program to be transmitted even when the received program is in a format different from the transmission format for the recording/reproducing apparatus 300.

Accordingly, program information such as information for a caption function, event time and title and channel rating can be recorded together with the video/audio signals.

Although a preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A digital video receiver, which receives and decodes a broadcasting program, creates a predetermined type of data stream and transmits a data stream to a recording/reproducing apparatus connected to the digital video receiver through an interface, the digital video receiver comprising:
a program information converter operable to convert program information included in the broadcasting program into a format suitable for the recording/reproducing apparatus; and
a stream generator operable to receive the converted program information and the decoded broadcasting program data, and further operable to create a data stream with the received information and data.

2. A digital video receiver as set forth in claim 1, further comprising a program information analyzer operable to analyze the program information included in the data stream.

3. A digital video receiver as set forth in claim 1, wherein said program information converter comprises a table generator operable to create at least one new table in a suitable format using at least one of a plurality of tables associated with the program information.

4. A digital video receiver as set forth in claim 1, wherein the program information is PSIP (Program and System Information Protocol) information and the broadcasting program is in Advanced Television Systems Committee (ATSC) format.

5. A digital video receiver as set forth in claim 4, wherein at least one of a selection information table (SIT), a discontinuity information table (DIT), a program association table (PAT), and a program map table (PMT) is created using information contained in at least one of a Virtual Channel Table (VCT), Master Guide Table (MGT), System Time Table (STT), Event Information Table (EIT) and Extended Text Table (ETT) tables of the PSIP information.

6. A digital video receiver as set forth in claim 1, wherein the interface is in accordance with the IEEE1394 standard.

7. A stream creating method of a digital video receiver that receives and decodes a broadcasting program, creates a predetermined type of data stream, and then transmits the data stream to a recording/reproducing apparatus connected thereto through an interface, the stream creating method comprising:
(a) converting program information included in the broadcasting program into a format suitable for the recording/reproducing apparatus that is connected to the digital video receiver through the interface; and
(b) creating a data stream comprising the converted program information.

8. A stream creating method as set forth in claim 7, further comprising analyzing the program information in the data stream.

9. A stream creating method as set forth in claim 7, wherein said converting operation comprises creating at least one new table in a suitable format for recording by using at least one among a plurality of tables of the program information.

10. A stream creating method as set forth in claim 7, wherein the program information is Program and System Information Protocol (PSIP) information and the broadcasting program is in Advanced Television Systems Committee (ATSC) format.

11. A stream creating method as set forth in claim 10, wherein at least one of a selection information table (SIT), a discontinuity information table (DIT), a program association table (PAT), and a program map table (PMT) is created using at least one of a Virtual Channel Table (VCT), Master Guide Table (MGT), System Time Table (STT), Event Information Table (EIT) and Extended Text Table (ETT) tables of the PSIP information.

12. A stream creating method as set forth in claim 7, wherein the interface is in accordance with the IEEE1394 standard.

13. A digital receiver for receiving digital data corresponding to a program and transmitting the received data to a recording device in a compatible format, the digital receiver comprising:
an input means for receiving the digital data corresponding to the program, wherein the digital data comprises at least audio data, video data and informational data corresponding to the program;
an information decoder operable to decode the informational data; and
a program converter operable to convert the decoded informational data into the compatible format.

14. A digital receiver as set forth in claim 13, further comprising an information analyzer operable to separate the decoded informational data into a plurality of groups, wherein the groups are distinguished by a type of information regarding the program.

15. A digital receiver as set forth in claim 14, wherein the informational data is PSIP data in accordance with ATSC standards and the groups comprise at least one of EIT and ETT data.

16. A digital receiver as set forth in claim 13, further comprising:
a video decoder operable to decode the video data;
an audio decoder operable to decode the audio data; and
a bit-stream generator operable to receive the decoded video, audio and informational data and generate a stream of data in a format compatible with the recording device.

17. A digital receiver as set forth in claim 16, wherein the format compatible with the recording device is MPEG2 format.
